(19) United States
(12) Patent Application Publication
(10) Pub. No.: US 2025/0300163 A9
(43) Pub. Date: Sep. 25, 2025

(54) METHOD AND SYSTEM FOR CARBON-COATED SILICON IN A PYROLYZED CARBON BINDER ELECTRODE ON COPPER CURRENT COLLECTORS

(71) Applicant: Enevate Corporation, Irvine, CA (US)

(72) Inventors: Benjamin Park, Irvine, CA (US); Jill Pestana, Irvine, CA (US); Ian Browne, Irvine, CA (US); Younes Ansari, Irvine, CA (US); Sanjaya D. Perera, Irvine, CA (US)

(21) Appl. No.: 17/319,726

(22) Filed: May 13, 2021

Related U.S. Application Data
(63) Continuation-in-part of application No. 16/430,306, filed on Jun. 3, 2019.
Application No. 16/430,306 is a continuation-in-part of application No. 15/471,860, filed on Mar. 28, 2017, now abandoned.

(51) Int. Cl. H01M 4/134; H01M 4/02; H01M 4/04; H01M 4/1395; H01M 4/36; H01M 4/38; H01M 4/587; H01M 4/66; H01M 10/0525

(52) U.S. Cl. CPC H01M 4/134; H01M 4/0404; H01M 4/0423; H01M 4/0428; H01M 4/1395; H01M 4/366; H01M 4/386; H01M 4/587; H01M 4/662; H01M 10/0525; H01M 2004/021; H01M 2004/027

(57) ABSTRACT

A method and system for carbon-coated silicon in a pyrolyzed carbon binder electrode on copper current collectors may include providing a metal current collector; forming a non-porous carbon coating on the metal current collector; coating silicon particles with carbon; forming an active material layer on the metal current collector, where the active material layer comprises at least 50% silicon particles by weight and a carbon source; and pyrolyzing the active material layer on the metal current collector, with no silicon particles in contact with metal from the metal current collector. The metal current collector may include copper. The battery anode may include no copper-silicon eutectic. The silicon particles may range in size from 2 to 50 μm. The active material layer may include aluminum carbide. A source for the pyrolyzed carbon may include polyimide and/or polyamide-imide. The current collector may be coated with the non-porous carbon coating using physical vapor deposition.

### CROSS-REFERENCE TO RELATED APPLICATIONS/INCORPORATION BY REFERENCE

N/A

### FIELD

Aspects of the present disclosure relate to energy generation and storage. More specifically, certain embodiments of the disclosure relate to a method and system for carbon-coated silicon in a pyrolyzed carbon binder electrode on copper current collectors.

### BACKGROUND

Conventional approaches for forming an anode may be costly, cumbersome, and/or inefficient—e.g., they may be complex and/or time consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method for carbon-coated silicon in a pyrolyzed carbon binder electrode on copper current collectors, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a diagram of a battery, in accordance with an example embodiment of the disclosure.

FIG. 2 is a flow diagram of a direct coating process for forming a silicon-dominant anode cell, in accordance with an example embodiment of the disclosure.

FIG. 3 illustrates a silicon-dominant anode with carbon-coated current collector and silicon particles, in accordance with an example embodiment of the disclosure.

FIG. 4 illustrates a current collector coating apparatus, in accordance with an example embodiment of the disclosure.

FIG. 5 illustrates the copper-silicon phase diagram, in accordance with an example embodiment of the disclosure.

FIG. 6 illustrates the silicon-carbon phase diagram, in accordance with an example embodiment of the disclosure.

FIG. 7 illustrates a portion of the copper-carbon phase diagram, in accordance with an embodiment of the disclosure.

FIG. 8 illustrates the aluminum-carbon phase diagram, in accordance with an example embodiment of the disclosure.

FIG. 9 illustrates the aluminum-silicon phase diagram, in accordance with an example embodiment of the disclosure.

FIG. 10 illustrates a portion of the iron-carbon phase diagram, in accordance with an example embodiment of the disclosure.

FIG. 11 illustrates the iron-silicon phase diagram, in accordance with an example embodiment of the disclosure.

FIG. 12 illustrates the aluminum-copper phase diagram, in accordance with an example embodiment of the disclosure.

FIG. 13 illustrates scanning electron microscopy images of an anode active material layer, in accordance with an example embodiment of the disclosure.

FIG. 14 illustrates higher magnification scanning electron microscopy images of an anode active material layer, in accordance with an example embodiment of the disclosure.

FIG. 15 illustrates scanning electron microscopy energy dispersive x-ray spectroscopy (SEM EDS) analysis of two locations on an active material layer alloy particle, in accordance with an example embodiment of the disclosure.

### DETAILED DESCRIPTION

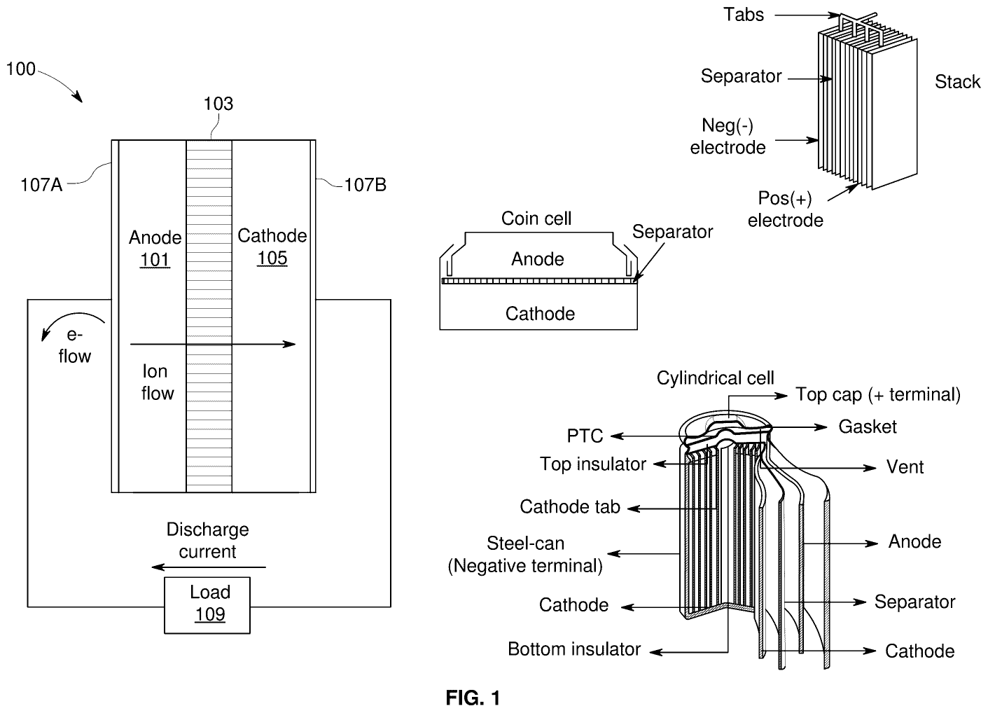

FIG. 1 is a diagram of a battery with silicon-dominant anodes, in accordance with an example embodiment of the disclosure. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack. Furthermore, the battery 100 shown in FIG. 1 is a very simplified example merely to show the principle of operation of a lithium ion cell. Examples of realistic structures are shown to the right in FIG. 1, where stacks of electrodes and separators are utilized, with electrode coatings typically on both sides of the current collectors. The stacks may be formed into different shapes, such as a coin cell, cylindrical cell, or prismatic cell, for example.

The development of portable electronic devices and electrification of transportation drive the need for high performance electrochemical energy storage. Small-scale (<100 Wh) to large-scale (>10 KWh) devices primarily use lithium-ion (Li-ion) batteries over other rechargeable battery chemistries due to their high-performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode are electrically coupled to the current collectors 107A and 107B, which comprise metal or other conductive material for providing electrical contact to the electrodes as well as physical support for the active material in forming electrodes.

The configuration shown in FIG. 1 illustrates the battery 100 in discharge mode, whereas in a charging configuration, the load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄ etc. In an example scenario, the electrolyte may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.1 to 2.0 molar (M) and lithium bis(trifluoromethanesulfonyl)imide (LiTFSI) may be present at a concentration of about 0 to 2.0 molar (M). Solvents may comprise one or more of ethylene carbonate (EC), fluoroethylene carbonate (FEC) and/or ethyl methyl carbonate (EMC) in various percentages. In some embodiments, the electrolyte solvents may comprise one or more of EC from about 0-40%, FEC from about 2-40% and/or EMC from about 50-70%

The separator 103 may be wet or soaked with a liquid or gel electrolyte. In addition, in an example embodiment, the separator 103 does not melt below about 100 to 120° C., and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not conductive enough to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material that includes a current collector such as a copper sheet or a copper alloy sheet. Carbon is often used because it has excellent electrochemical properties and is also electrically conductive. Anode electrodes currently used in rechargeable lithium-ion cells typically have a specific capacity of approximately 200 milliamp hours per gram. Graphite, the active material used in most lithium ion battery anodes, has a theoretical energy density of 372 milliamp hours per gram (mAh/g). In comparison, silicon has a high theoretical capacity of 4200 mAh/g. In order to increase volumetric and gravimetric energy density of lithium-ion batteries, silicon may be used as the active material for the cathode or anode. Silicon anodes may be formed from silicon composites, with more than 50% silicon or more by weight in the anode material on the current collector, for example.

In an example scenario, the anode 101 and cathode 105 store the ion used for separation of charge, such as lithium. In this example, the electrolyte carries positively charged lithium ions from the anode 101 to the cathode 105 in discharge mode, as shown in FIG. 1 for example, and vice versa through the separator 105 in charge mode. The movement of the lithium ions creates free electrons in the anode 101 which creates a charge at the positive current collector 107B. The electrical current then flows from the current collector through the load 109 to the negative current collector 107A. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. Carbon black (SuperP), vapor grown carbon fibers (VGCF), and a mixture of the two have previously been incorporated separately into the anode electrode resulting in improved performance of the anode. The synergistic interactions between the two carbon materials may facilitate electrical contact throughout the large volume changes of the silicon anode during charge and discharge.

State-of-the-art lithium-ion batteries typically employ a graphite-dominant anode as an intercalation material for lithium. Silicon-dominant anodes, however, offer improvements compared to graphite-dominant Li-ion batteries. Silicon exhibits both higher gravimetric (4200 mAh/g vs. 372 mAh/g for graphite) and volumetric capacities (2194 mAh/L vs. 890 mAh/L for graphite). In addition, silicon-based anodes have a low lithiation/delithiation voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life.

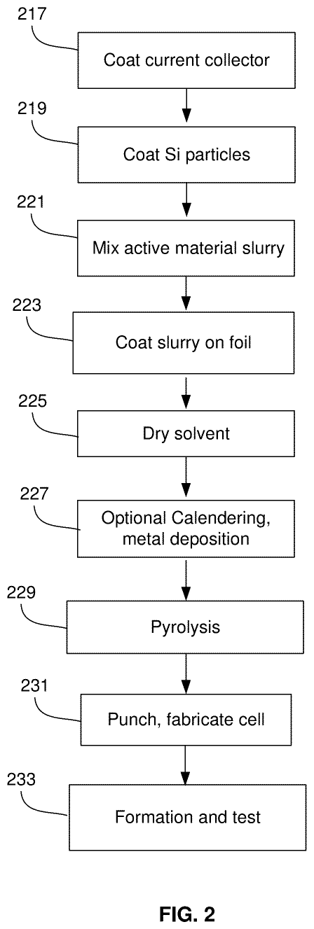

FIG. 2 is a flow diagram of a direct coating process for forming a silicon-dominant anode cell, in accordance with an example embodiment of the disclosure. This process comprises physically mixing the active material, conductive additive, and binder together, and coating it directly on a current collector before pyrolysis. This example process comprises a direct coating process in which an anode or cathode slurry is directly coated on a carbon-coated copper foil using a binder such as CMC, SBR, Sodium Alginate, PAI, PI and mixtures and combinations thereof.

Silicon-dominant anodes may have issues during pyrolysis if silicon is in contact with copper at high temperatures, because the temperature range is limited by the melting point of the copper-silicon eutectic mixture. In an example embodiment, an electrode may be provided comprising a Si—C composite active material layer with carbon coating on Si phases (particles) coated on a carbon coating on the copper foil current collector. In this manner, there may be a carbon layer between silicon and copper at all points within the electrode. The binder may comprise pyrolyzed carbon from different polymers (polyacrylic acid (PAA), PAI, PI, water based PAI, phenolic resins, tar, pitch, etc). The entire electrode may undergo pyrolysis at temperatures between 600 and ˜1084° C. (below the melting point of Cu), between 700 and 1084° C., between 800 and 1084° C., or between 900 and 1084° C. The Si, Cu, and C may be allowed to react or be purposely prevented from reacting, as is the case of Si and Cu, and form different phases. The combination of a carbon coated current collector and carbon coated silicon may be used to prevent direct contact of silicon and the current collector during pyrolysis. The current collector coating may have substantially different properties from the primary carbon matrix, such as purity, electrical conductivity, density, Young's modulus, porosity, pore size, and/or pore morphology.

In step 217, current collector may be coated with a non-porous carbon layer. The current collector may be coated with an electronically conductive form of a non-porous carbon or an electronic conductive form of a carbon without through-pores to prevent a direct contact between silicon particles and the current collector during pyrolysis. The coating layer may be robust enough to keep the structural integrity of the layer upon further processes including coating, winding, unwinding, and pyrolysis. The carbon may be deposited using a physical vapor deposition (PVD) process, for example. The carbon-coated copper current collector prevents reactions between the silicon and copper and thereby expands the allowable temperature range for pyrolytic carbon conversion of the carbon matrix in the silicon carbon composite electrode, which may provide a carbon matrix with more desirable properties.

The current collector may be coated using various techniques, such as gravure coating, transfer coating, slot die coating, precipitation or flocculation, or vapor deposition. In these examples, carbon particles may be suspended in a solution or mixture of polymers or polymer precursors, which may be applied to the copper surface to create a carbon-based or carbon-filled polymer coating. The current collector may also be coated with a high char yield polymer such as Torlon® 4000T that is not soluble in the subsequent slurry from step 223 used to prepare the electrode in steps 223 through 231, and may form a conformal coating on the silicon particles before the pyrolysis process.

In the case of precipitation for coating the current collector, the mechanism of precipitation may be in situ polymerization or modification of the solvent properties, such as the addition of salt or a flocculant to decrease the solubility of the polymer. In another example, vapor deposition may be utilized to coat the current collector foil. The copper foil may be exposed to polymer precursors in a vapor phase or other chemical vapor deposition (CVD) or PVD chamber/system or continuous system. In certain embodiments, a low-pressure continuous roll-to-roll system is preferred due to lower cost and faster throughput vs a batch chamber system.

In step 219, silicon particles may be coated with a high char yield polymer that is not soluble in the slurry of step 221 and may form a conformal coating on the silicon particles before the pyrolysis process of step 229 where the coating prevents direct contact between silicon and the current collector. Such coating may also provide improved mechanical strength to the active material matrix to avoid disintegration caused by high volume change in silicon particles during cycling. In one example, the silicon particles may comprise silicon coated with Torlon® 4000T, or any NMP soluble PAI or PI used in an aqueous based slurry. The silicon particles may be coated using a variety of methods such as precipitation or flocculation. The silicon particles may be suspended in a solution or mixture of polymers or polymer precursors, which may precipitate or flocculate on the silicon particle surface and create a polymer coating. The mechanism of precipitation may be in situ polymerization or modification of the solvent properties, such as the addition of salt, acid, base, or a flocculant to decrease the solubility of the polymer.

Another option is microencapsulation where silicon particles may be suspended in a solution or mixture of polymers or polymer precursors and encapsulated via spray drying, where atomized droplets of the suspension are dried in mid-air. A third option for silicon particle coating comprises vapor deposition. In this scenario, silicon particles may be suspended in a fluidized bed and exposed to polymer precursors in a vapor phase or other CVD or PVD system.

These coated particles may then be thermally treated to generate a carbon-coated silicon particle (for example in a fluidized bed), or may be incorporated into a composite film which may be subsequently thermally treated. The composite film may be prepared by suspending the polymer-coated silicon particles in a suitable binder solution, which is then coated on a substrate. A suitable binder solution may be one which does not cause removal or degradation of the particle coating created in prior manufacturing steps.

In step 221, the active material may be mixed, e.g., a binder/resin (such as PI, PAI), solvent, and conductive additives. The materials may comprise carbon nanotubes/fibers, graphene sheets, metal polymers, metals, semiconductors, and/or metal oxides, for example. Silicon powder with a 5-30 μm particle size, for example, and carbon coating as described above may then be dispersed in polyamic acid resin (15% solids in N-Methyl pyrrolidone (NMP) or water) at, e.g., 1000 rpm for, e.g., 10 minutes, and then the conjugated carbon/NMP or water slurry may be added and dispersed at, e.g., 2000 rpm for, e.g., 10 minutes to achieve a slurry viscosity within 2000-4000 cP and a total solid content of about 30%. The silicon particles may be coated with high char-yield polymeric resins that are soluble in water. The polymeric resins may comprise two or more polymer components. The secondary polymer component may consist of functional groups that facilitate the dispersion of Si in water, when used as the solvent. The silicon particles may be coated by an atomic layer deposition (ALD) process equipped with a fluidized bed reactor, for example, to ensure a conformal coating.

Furthermore, cathode active materials may be mixed in step 221, where the active material may comprise lithium cobalt oxide (LCO), lithium iron phosphate, lithium nickel cobalt manganese oxide (NMC), lithium nickel cobalt aluminum oxide (NCA), lithium manganese oxide (LMO), lithium nickel manganese spinel, or similar materials or combinations thereof, mixed with a binder as described above for the anode active material.

In step 223, the slurry may be coated on the carbon-coated copper foil. In the direct coating process described here, an anode slurry is coated on a current collector with residual solvent followed by a calendaring process for densification followed by pyrolysis, such that carbon precursors are partially or completely converted into glassy carbon.

Similarly, cathode active materials may be coated on a foil material, such as aluminum, for example. The active material layer may undergo a drying in step 225 resulting in reduced residual solvent content. An optional calendering process may be utilized in step 227 where a series of hard pressure rollers may be used to finish the film/substrate into a smoother and denser sheet of material. In addition, a metal layer may be deposited on a surface of the dried film opposite to the side on which the current collector is later coupled. The metal layer may be deposited using physical vapor deposition (PVD), chemical vapor deposition (CVD), or by applying a thin foil, for example.

In step 229, the active material may be pyrolyzed by heating to 500-1084° C. such that carbon precursors are partially or completely converted into glassy carbon. The pyrolysis temperature may range between 500 and 1084° C. (below the melting point of Cu), between 600 and 1084° C., between 700 and 1084° C., between 800 and 1084° C., or between 900 and 1084° C., for example. The carbon coating on the current collector as well as on the silicon particles ensures that silicon does not come in contact with the copper during pyrolysis. The polymer coated silicon particles may be converted to a conformal carbon coating on the silicon particles via pyrolysis. Pyrolysis can be done either in roll form or after punching. If done in roll form, the punching is done after the pyrolysis process. The pyrolysis step may result in an anode active material having silicon content greater than or equal to 50% by weight, where the anode has been subjected to heating at or above 400 degrees Celsius. In an example scenario, the anode active material layer may comprise 20 to 95% silicon and in yet another example scenario may comprise 50 to 95% silicon by weight. In instances where the current collector foil is not pre-punched/pre-perforated, the formed electrode may be perforated with a punching roller, for example. The punched electrodes may then be sandwiched with a separator and electrolyte to form a cell.

In step 233, the cell may be assessed before being subject to a formation process. The measurements may comprise impedance values, open circuit voltage, and thickness measurements. During formation, the initial lithiation of the anode may be performed, followed by delithiation. Cells may be clamped during formation and/or early cycling. The formation cycles are defined as any type of charge/discharge of the cell that is performed to prepare the cell for general cycling and is considered part of the cell production process. Different rates of charge and discharge may be utilized in formation steps.

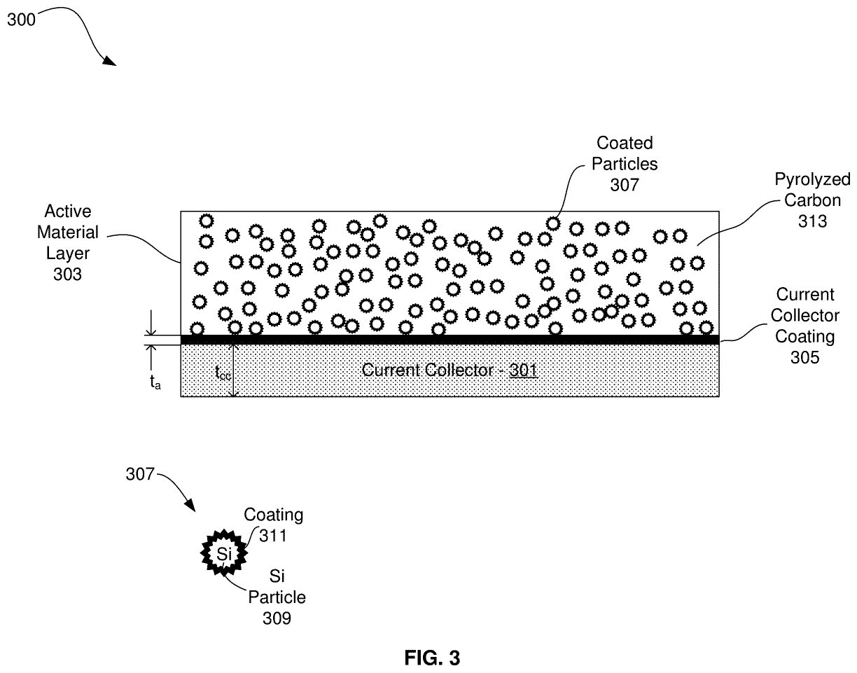

FIG. 3 illustrates a silicon-dominant anode with carbon-coated current collector and silicon particles, in accordance with an example embodiment of the disclosure. Referring to FIG. 3, there is shown anode 300 comprising current collector 301, active material layer 303, and current collector coating 305. The current collector 301 may comprise copper or other suitable metal for current collection in the electrode and providing electrical contact to an outside terminal, such as a tab as shown in FIG. 1. The thickness t_{cc} of the current collector 301 may range from about 5 microns up to tens of microns. The current collector coating 305 may comprise a non-porous carbon layer that ensures no contact between the silicon particles 307 and copper of the current collector 301. The coating layer may be robust enough to keep the structural integrity of the layer upon further processes including coating, winding, unwinding, and pyrolysis. The thickness to of the current collector coating may range from 100 nm to several microns or 10 nm to 1 micron, for example. As the current collector coating 305 is deposited directly on the current collector 301 as opposed to pyrolyzed polymer, the char yield of this layer after pyrolysis is 100%, or at least 95%, meaning that there is little or no composition change with associated outgassing of materials during pyrolysis.

The active material layer 303 may comprise pyrolyzed carbon 313 and coated particles 307. The active material layer 303 may comprise other materials, such as conductive additives, for example, not shown. The coated particles 307 may comprise silicon particles 309 with a coating 311, as shown in the lower inset. The silicon particles may range in size from several microns to tens of microns, so the size and number density of the particles 307 in FIG. 3 is not to scale. The coating 311 may be deposited as described above, and may ensure that there is no contact between silicon and copper in the anode 300.

The coating 311 on the silicon particles 309 and the current collector coating 305 enable high temperature pyrolysis of the anode 300, up to just below the melting point of the current collector 301, which is 1084° C. in the case of copper. In this manner, the coated particles 307 may be a drop-in replacement for graphite powder in a typical graphite-based lithium-ion cell process. The coating 311 may comprise carbon that has substantially different properties from the primary carbon matrix, such as purity, electrical conductivity, density, Young's modulus, porosity, pore size, or pore morphology. Because of the coating 311 and the current collector coating, no silicon is in contact with copper in the current collector 301. This may be confirmed using energy dispersive x-ray spectroscopy (EDAX) in conjunction with scanning electron microscopy (SEM) analysis of the anode cross-section, for example. Accordingly, no copper-silicon alloys or compounds are formed during pyrolysis.

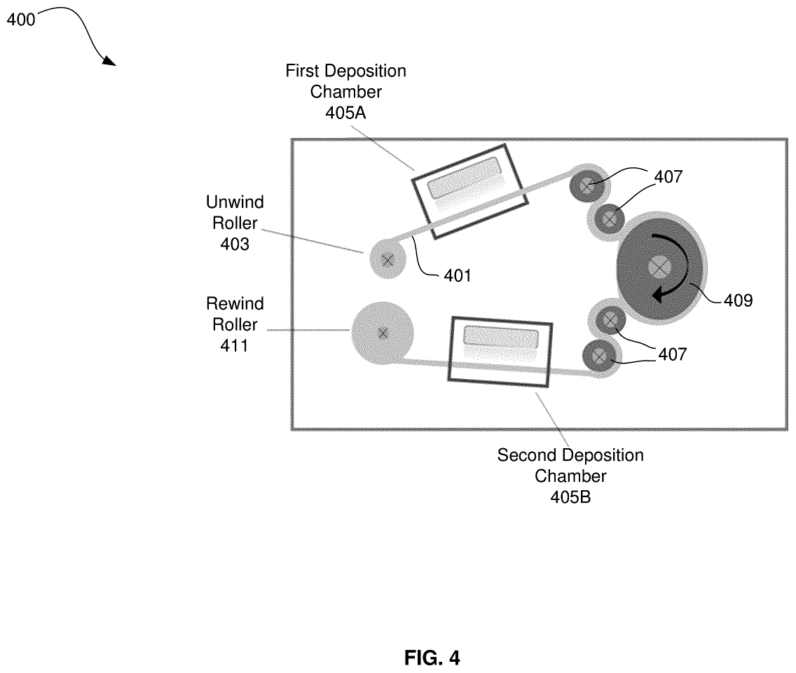

FIG. 4 illustrates a current collector coating apparatus, in accordance with an example embodiment of the disclosure. Referring to FIG. 4, there is shown deposition system 400 comprising a current collector foil 401, an unwind roller 403, first and second deposition chambers 405A and 405B, tensioner pulleys 407, drive pulley 409, and rewind roller 411.

In one example, the deposition chambers 405A and 405B comprise magnetron sputter coaters with carbon targets. In another example, the deposition chambers 405A and 405B may comprise diamond-like carbon coating (DLC) chambers that may deposit carbon based on high energy plasma processes and thermochemical diffusion reactions. DLC coating may have different ratios of SP³ and SP² or other fillers such as metallic layer. The ratio of SP³ and SP² of the carbon coating can be controlled so that the conductivity of the coating can be optimized while maintaining high hardness, and high corrosion resistance. In addition to the presence of carbon in the coating layer, intermetallic compounds may be formed with graphite to coat the current collector.

The current collector foil 401 may comprise a thin metal foil, such as copper, for example, that may have a thickness ranging from ˜5 μm to tens of μm, and may be wound around the unwind roller 403. The unwind roller 403 may comprise a cylindrical roller that may start with the uncoated metal foil for forming current collectors, and wound onto the rewind roller 411. The drive pulley 409 may comprise a cylindrical roller coupled to a drive mechanism, such as an electric motor, not shown, that once the current collector foil 401 is started unrolling from the unwind roller 403 and to the rewind roller 411, may provide a pulling force for the current collector foil 401 during the deposition process. The tensioners 407 may comprise cylindrical rollers with adjustable positions that can provide a desired tension on the current collector foil 401 to ensure a flat surface for deposition.

While the first end second deposition chambers 405A and 405B coat opposite sides of the current collector foil 401 to enable a fully coated foil, a single deposition chamber may be utilized if capable of depositing on both sides, or if it is desired to only coat one side.

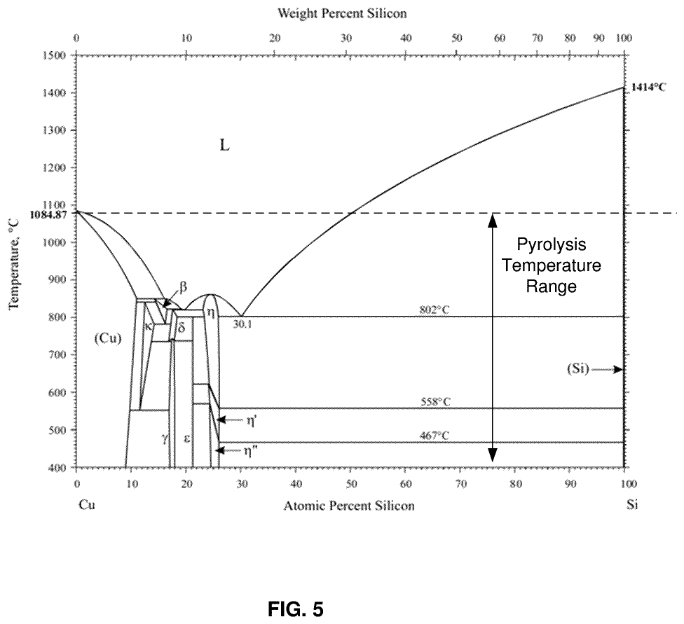

FIG. 5 illustrates the copper-silicon phase diagram, in accordance with an example embodiment of the disclosure. Referring to FIG. 5, the phase diagram for silicon and copper, originally from Okamoto, H. Cu—Si (Copper-Silicon). J. Phase Equilib. Diffus. 33, 415-416 (2012), show many possible phases in the temperature range used for pyrolysis up to just below the melting point of copper at 1084° C. In the ˜10 to 30% silicon concentration range, many phases may result, including eutectic alloys that may be liquid during pyrolysis, such that the liquid may cause further alloying and spread across the anode, damaging the active material layer.

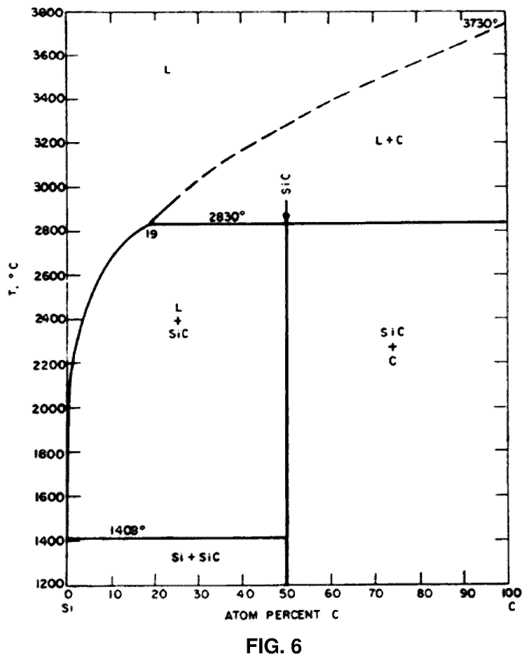

FIG. 6 illustrates the silicon-carbon phase diagram, in accordance with an example embodiment of the disclosure. Referring to FIG. 6, the phase diagram for silicon and carbon, originally from L. Y. Sadler, and M. Shamsuzzoha, “Response of Silicon Carbide to High-Intensity Laser Irradiation in a High-Pressure Inert Gas Atmosphere,” J. Materials Research, 22 (No. 1), 147-160 (1997), show fewer phases. The pyrolysis temperature range is below the range shown and the phase present are SiC+Si or SiC+C.

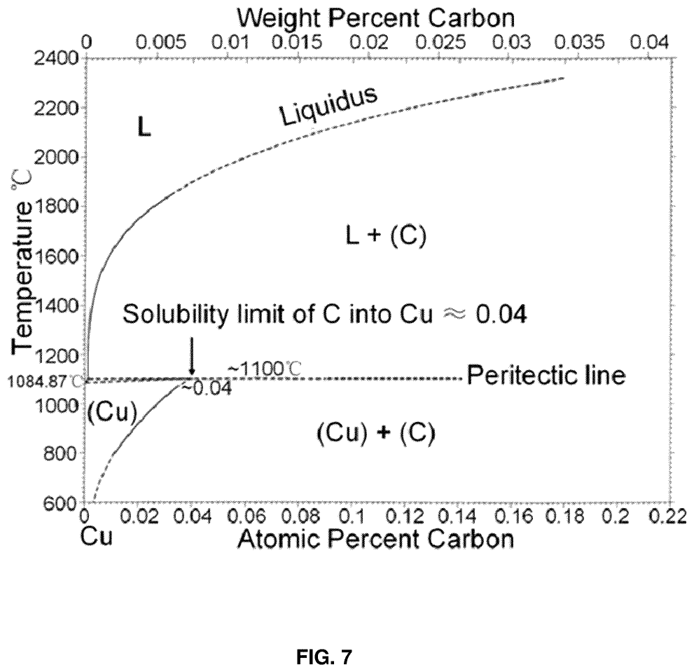

FIG. 7 illustrates a portion of the copper-carbon phase diagram, in accordance with an embodiment of the disclosure. Referring to FIG. 7, the phase diagram for copper and carbon, originally from Silvain, J. -F & Heintz, Jean-Marc & Veillère, A. & Constantin, Loic & Lu, Y. (2020). International Journal of Extreme Manufacturing, shows the solubility limit of carbon into copper around 0.04 atomic percent carbon, meaning carbon has minimal reaction with a copper current collector.

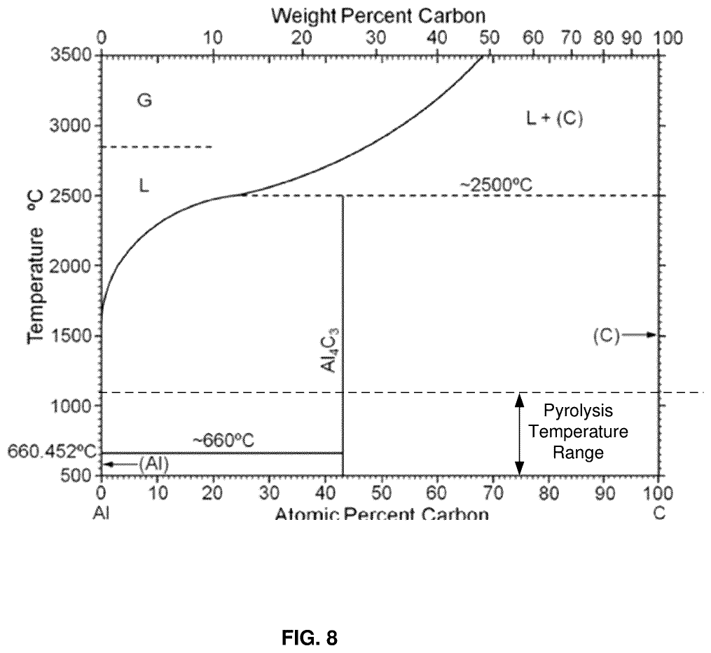

FIG. 8 illustrates the aluminum-carbon phase diagram, in accordance with an example embodiment of the disclosure. Referring to FIG. 8, the phase diagram for aluminum and carbon, originally from Dabouz, Rafik & Bendoumia, M. & Belaid, Lounes & Azzaz, Mohamed. (2019). Dissolution of Al 6% wt C Mixture Using Mechanical Alloying. Defect and Diffusion Forum. 391. 82-87, shows a small number of phases, where the melting point of aluminum of 660° C. is shown. Aluminum may be a dopant/impurity in the silicon, and may react with carbon in the binder to form an aluminum carbide phase during pyrolysis. Above 660° C., aluminum may react with carbon to form Al₃C₄. Certain types of silicon particles include iron and aluminum impurities as detected by X-ray photoelectron spectroscopy (XPS) and energy dispersive X-ray spectroscopy (EDS). These impurities can be concentrated in the surface of the particle, which allows for reactions between the impurities and anode materials. Aluminum reactants with carbon, copper, and silicon may provide better active material robustness and electrochemical performance. For example, Al₃C₄ may provide these benefits.

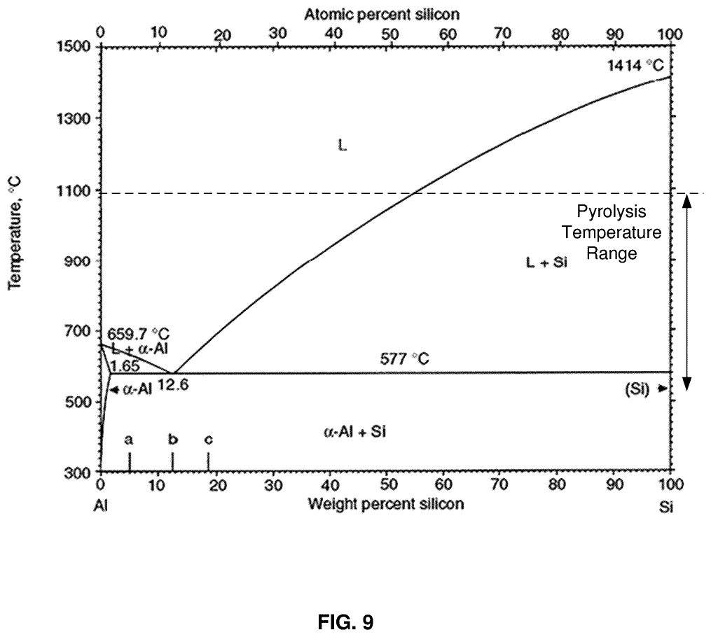

FIG. 9 illustrates the aluminum-silicon phase diagram, in accordance with an example embodiment of the disclosure. Referring to FIG. 9, the phase diagram for aluminum and silicon, originally from Miao, Qiuyu & Wu, Dongjiang & Chai, Dongsheng & Zhan, Yu & Bi, Guijun & Niu, Fangyong & Ma, Guangyi. (2019). Comparative study of microstructure evaluation and mechanical properties of 4043 aluminum alloy fabricated by wire-based additive manufacturing. Materials & Design. 186. 108205. 10.1016/j.matdes.2019.108205, shows an α-Al+Si phase across the entire silicon concentration range once below the aluminum melting point of 660° C.

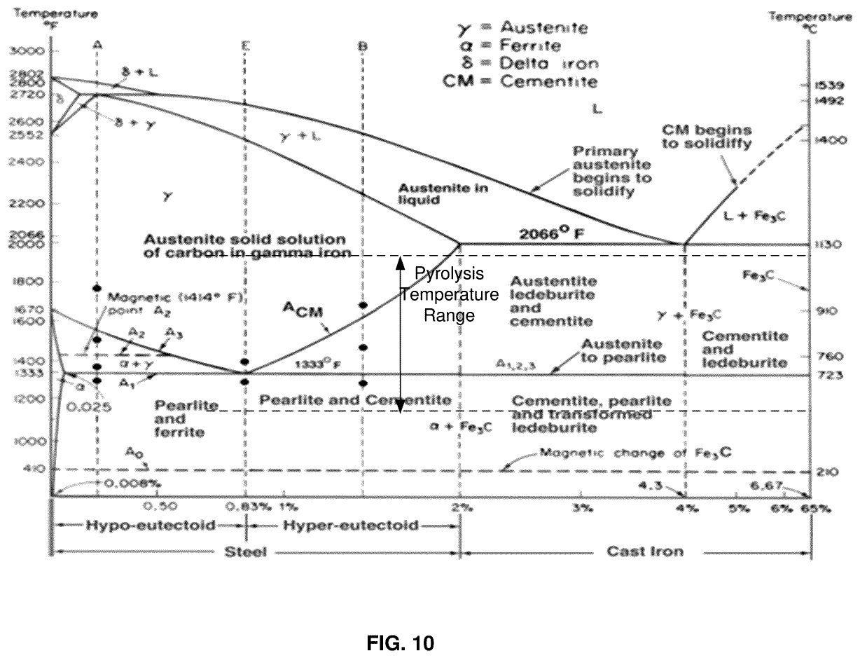

FIG. 10 illustrates a portion of the iron-carbon phase diagram, in accordance with an example embodiment of the disclosure. Referring to FIG. 10, the phase diagram for iron and carbon, originally from Ferguson, Lynn & Li, Zhichao & Sims, Justin & Yu, Tianyu. (2017). Vacuum Carburizing Steel Alloys Containing Strong Carbide Formers, is shown at the iron-rich side (>93%). Small amounts of Fe in the active material layer may form traces of Fe₃C that may be beneficial to cell performance.

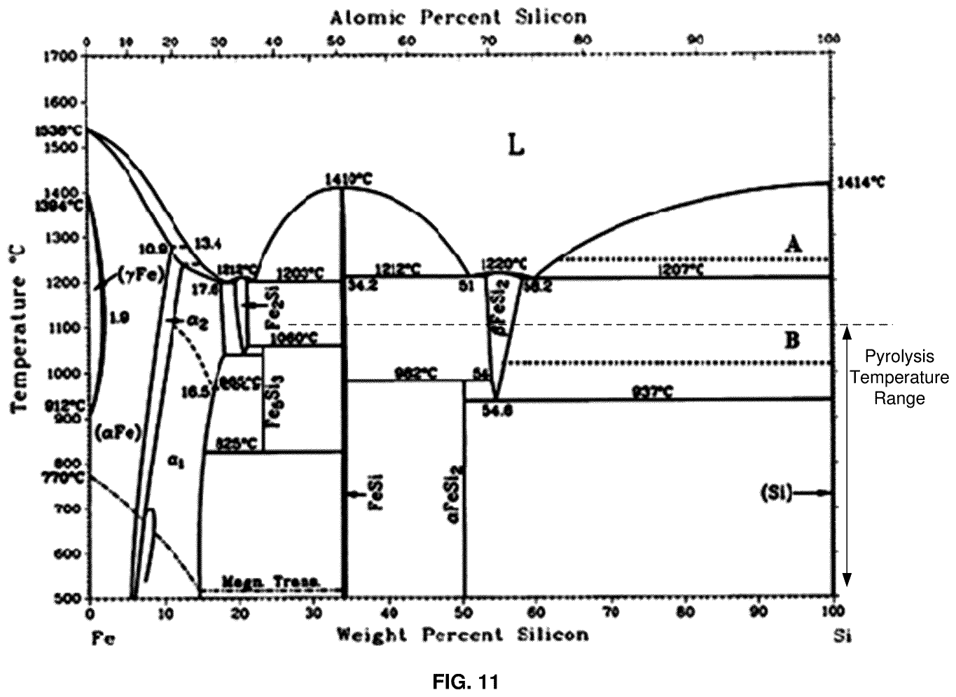

FIG. 11 illustrates the iron-silicon phase diagram, in accordance with an example embodiment of the disclosure. Referring to FIG. 11, the phase diagram for iron and silicon, originally from Esfahani, Shaghayegh (Sherry) & Barati, Mansoor. (2011). Purification of Metallurgical Silicon using Iron as an Impurity Getter Part I: Growth and Separation of Si. Metals and Materials International. 17. 10.1007/s12540-011-1021-3., shows just an α-FeSi₂ phase possible for silicon-dominant anodes. Fe in the active material layer may form Fe₂Si above 200° C., and Fe₃Si₇ above 947° C. Iron reactants with carbon, copper, and silicon may provide better active material robustness and electrochemical performance. For example, Fe₂Si and Fe₃Si₇ may provide these benefits.

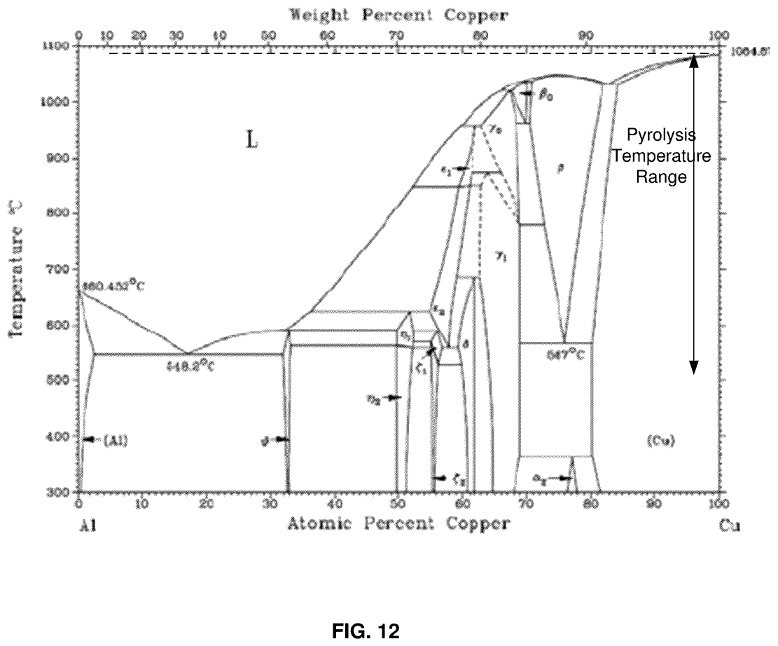

FIG. 12 illustrates the aluminum-copper phase diagram, in accordance with an example embodiment of the disclosure. Referring to FIG. 12, the phase diagram for aluminum and copper, originally from Tian, Yanhong & Hang, C. & Wang, Chunqing & Zhou, Yixiang. (2007). Evolution of Cu/AI Intermetallic Compounds in the Copper Bump bonds during Aging Process. IEEE Electron Package Technol. 10.1109/ICEPT.2007.4441444, shows that at high copper concentrations, such as in a copper current collector, a single possible phase for aluminum in copper. Aluminum reactants with carbon, copper, and silicon may have better active material robustness and electrochemical performance. For example, copper-aluminum alloys and Al₃C₄ may provide these benefits.

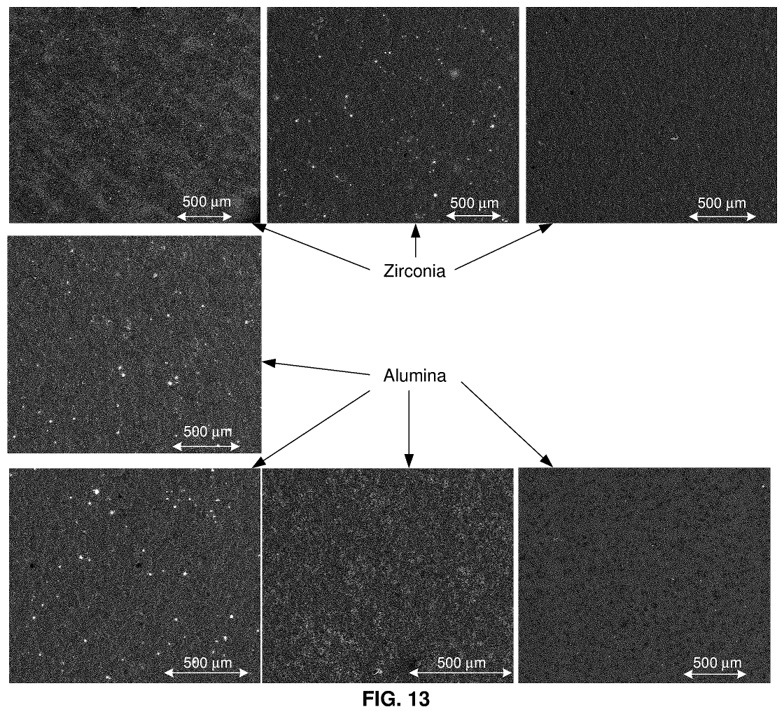

FIG. 13 illustrates scanning electron microscopy (SEM) images of an anode active material layer, in accordance with an example embodiment of the disclosure. Referring to FIG. 13, there is shown active material layers with zirconia or alumina media in the slurry. The bright specks correspond to alloys formed during pyrolysis from impurities in the silicon, zirconia/alumina, and/or additives. The alloys may comprise silicon, aluminum, iron, carbon, and oxygen, for example.

The number of alloy particles may impact anode performance in a cell through reduced impedance, increased mechanical strength and flexibility, and lower energy required to lithiate silicon. Furthermore, coating the silicon particles may provide a barrier for side reactions between the electrolyte and impurities in the silicon. The images shown in FIG. 13 show an alloy particle areal density range from 50 to 2000 mm⁻², where desired densities may be 100 to 2000 mm⁻², 200-2000 mm⁻², 400-2000 mm⁻², or 1000 to 2000 mm⁻², for example. In some examples, it may be advantageous to have more than 200 mm⁻², more than 500 mm⁻², more than 700 mm⁻², or more than 1000 mm⁻².

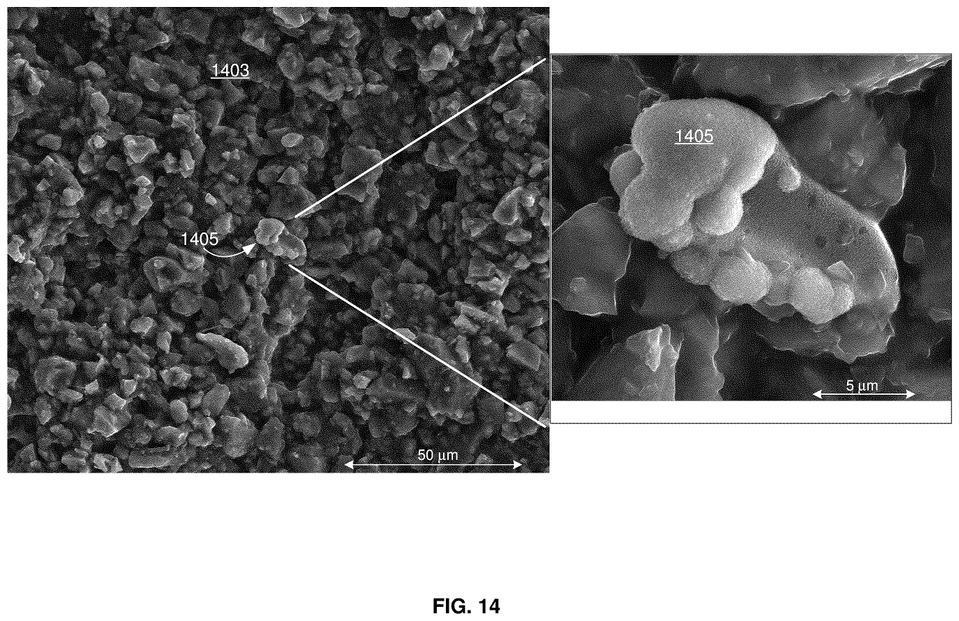

FIG. 14 illustrates higher magnification scanning electron microscopy images of an anode active material layer, in accordance with an example embodiment of the disclosure. Referring to FIG. 14, there is shown active material layer 1403 with an alloy particle 1405, with the right image showing a zoomed-in view of the particle 1405. The images show the granular structure that results from pyrolyzing the slurry with silicon particles, binder, and additives such as zirconia or alumina.

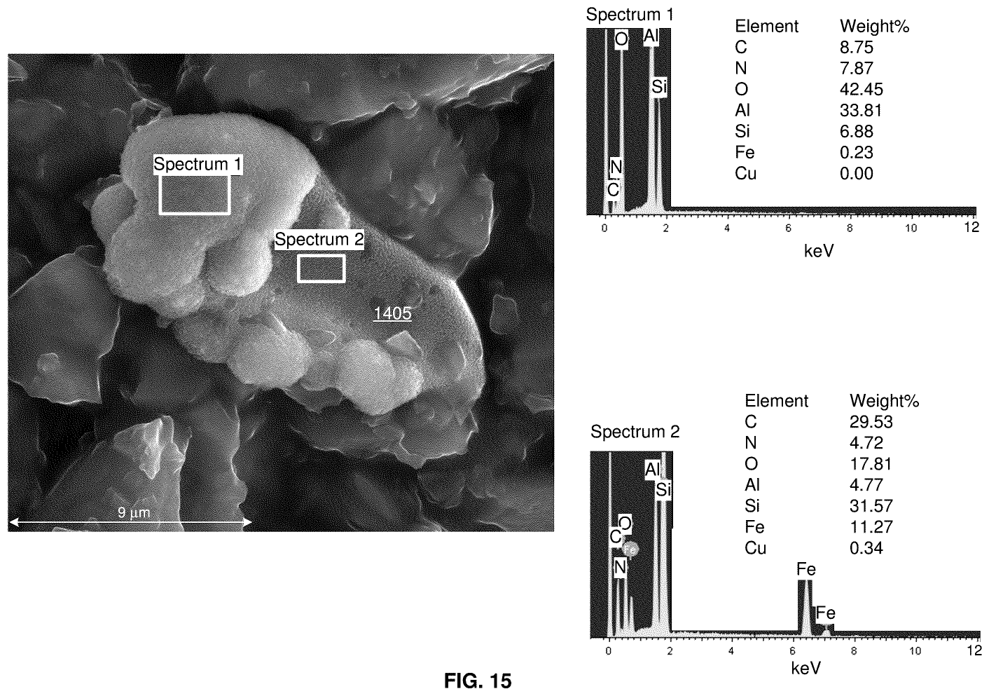

FIG. 15 illustrates scanning electron microscopy energy dispersive x-ray spectroscopy (SEM EDS) analysis of two locations on an active material layer alloy particle, in accordance with an example embodiment of the disclosure. Referring to FIG. 15, Spectrum 1 and Spectrum 2 are indicated on the SEM image on the left, which correlate to the spectra shown in the right. As indicated by the relative smooth shading of the particle 1405, the particle comprises alloys as opposed to discrete elements. The Spectrum 1 location is mostly aluminum and oxygen with lower levels of carbon, nitrogen, and silicon. The Spectrum 2 location of the particle 1405 is mostly silicon and carbon with lower levels of iron, oxygen, and aluminum, indicating that the particle 1405 is likely an alloy formed from a carbon-coated silicon particle and alumina additive, the alloy being formed during pyrolysis.

In an example embodiment of the disclosure, a method and system is described for carbon-coated silicon in a pyrolyzed carbon binder electrode on copper current collectors, and may include providing a metal current collector; forming a non-porous carbon coating on the metal current collector; coating silicon particles with carbon; forming an active material layer on the metal current collector, where the active material layer comprises at least 50% silicon particles by weight and a carbon source; and pyrolyzing the active material layer on the metal current collector, where no silicon particles are in contact with metal in or from the metal current collector following pyrolysis.

The metal current collector may comprise copper or copper alloy. The battery anode may comprise no copper-silicon eutectic. The silicon particles may range in size from 2 to 50 μm. The active material layer may comprise aluminum carbide. A source for the pyrolyzed carbon may comprise polyimide, polyamide-imide, and other types of polymer such as phenolic, PAA, or aqueous-based polymers. The metal current collector may be coated with the non-porous carbon coating using physical vapor deposition (PVD). The silicon particles may be coated with carbon using an atomic layer deposition (ALD) process using a fluidized bed reactor. The active material layer may be pyrolyzed on the metal current collector in a temperature range of 500 to 1084° C., in a temperature range of 600 to 1084° C., in a temperature range of 700 to 1084° C., in a temperature range of 800 to 1084° C., or in a temperature range of 900 to 1084° C. The active material layer may comprise one or more of: FeC₃, Fe₂Si, Fe₃Si₇, Al₃C₄, and copper-aluminum alloys. The active material layer may comprise alloy particles with an areal density range from 50 to 2000 mm⁻², where desired densities may be 100 to 2000 mm⁻², 200-2000 mm⁻², 400-2000 mm⁻², or 1000 to 2000 mm⁻², for example. In some examples, it may be advantageous to have alloy particle areal densities of more than 200 mm⁻², more than 500 mm⁻², more than 700 mm⁻², or more than 1000 mm⁻².

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a battery, circuitry or a device is “operable” to perform a function whenever the battery, circuitry or device comprises the necessary hardware and code (if any is necessary) or other elements to perform the function, regardless of whether performance of the function is disabled or not enabled (e.g., by a user-configurable setting, factory trim, configuration, etc.).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method of forming a battery, the method comprising:
providing a metal current collector;
forming a non-porous carbon coating on the metal current collector;
coating silicon particles with a first carbon to form carbon-coated, encapsulated silicon particles;
forming an active material layer on the non-porous carbon coating on the metal current collector
incorporating the carbon-coated, encapsulated silicon particles into the active material layer, the active material layer comprising at least 50% of the carbon-coated, encapsulated silicon particles by weight and a carbon source including a second carbon different from the first carbon; and
pyrolyzing the active material layer on the metal current collector, wherein no carbon-coated, encapsulated silicon particles of the active material layer are in contact with metal in or from the metal current collector following pyrolysis due to the non-porous carbon coating on the metal current collector or the carbon-coated, encapsulated silicon particles.

2. The method of claim 1, wherein the metal current collector comprises copper or copper alloy.

3. The method of claim 2, wherein the battery comprises a battery anode that comprises no copper-silicon eutectic.

4. The method of claim 1, wherein the silicon particles range in size from 2 to 50 μm.

5. The method of claim 1, wherein the active material layer comprises aluminum carbide.

6. The method of claim 1, wherein the carbon source comprises one or more of: polyimide, polyamide-imide, polyacrylonitrile, phenolic, water based PAI, phenolic resins, tar, and pitch.

7. The method of claim 1, comprising coating the metal current collector with the non-porous carbon coating using physical vapor deposition.

8. The method of claim 1, comprising coating the silicon particles with the first carbon using an atomic layer deposition (ALD) process using a fluidized bed reactor.

9. The method according to claim 1, comprising coating the silicon particles with polymer using microencapsulation.

10. The method of claim 2, comprising pyrolyzing the active material layer on the metal current collector in a temperature range of 500 to 1084° C.

11. The method of claim 2, comprising pyrolyzing the active material layer on the metal current collector in a temperature range of 600 to 1084° C.

12. The method of claim 2, comprising pyrolyzing the active material layer on the metal current collector in a temperature range of 700 to 1084° C.

13. The method of claim 2, comprising pyrolyzing the active material layer on the metal current collector in a temperature range of 800 to 1084° C.

14. The method of claim 2, comprising pyrolyzing the active material layer on the metal current collector in a temperature range of 900 to 1084° C.

15. The method of claim 1, wherein the active material layer comprises one or more of: FeC₃, Fe₂Si, Fe₃Si₇, Al₃C₄, and copper-aluminum alloys.

16. The method of claim 1, wherein the active material layer comprises alloy particles with a density per area of greater than 200 mm⁻².

17. A battery anode comprising:
a metal current collector, the metal current collector having a non-porous carbon coating; and
an active material layer on the metal current collector, the active material layer comprising a pyrolyzed carbon source including a first carbon and at least 50% silicon by weight, wherein the silicon comprises heat treated carbon-coated silicon particles coated with a second carbon different from the first carbon incorporated within the pyrolyzed carbon source, and wherein none of the silicon is in contact with metal in or from the metal current collector.

18. The battery anode of claim 17, wherein the metal current collector comprises copper.

19. The battery anode of claim 18, wherein the battery anode comprises no copper-silicon eutectic.

20. The battery anode of claim 17, wherein the silicon comprises particles that range in size from 2 to 50 μm.

21. The battery anode of claim 17, wherein the active material layer comprises aluminum carbide.

22. The battery anode of claim 17, wherein the pyrolyzed carbon source comprises one or more of: polyimide, polyamide-imide, polyacrylonitrile, phenolic, water based PAI, phenolic resins, tar, and pitch.

23. The battery anode of claim 17, wherein the active material layer comprises one or more of: FeC₃, Fe₂Si, Fe₃Si₇, Al₃C₄, and copper-aluminum alloys.

24. The battery anode of claim 17, wherein the active material layer comprises alloy particles with a density per area of greater than 200 mm⁻².

25. A method of forming a battery, the method comprising:
providing a copper current collector;
forming a non-porous carbon coating on the copper current collector;
coating silicon particles with a first carbon to form carbon-coated silicon particles;
thermally treating the carbon-coated silicon particles;
forming an active material layer on the non-porous carbon coating on the copper current collector;
incorporating the thermally treated carbon-coated silicon particles into the active material layer, the active material layer comprising at least 50% of the carbon-coated silicon particles by weight and a carbon source including a second carbon different from the first carbon; and
pyrolyzing the active material layer on the copper current collector in a temperature range of 500 to 1084° C., wherein no carbon-coated silicon particles are in contact with metal in or from the copper current collector following pyrolysis.
